(19) United States
(12) Patent Application Publication
(10) Pub. No.: US 2012/0023177 A1
(43) Pub. Date: Jan. 26, 2012

(54) Tool for the Centralized Supervision and/or Hypervision of a Set of Systems Having Different Security Levels

(75) Inventor: Jean-Christophe Linden, Beauchamp (FR)

(73) Assignee: THALES, Neuilly Sur Seine (FR)

(21) Appl. No.: 13/125,760

(22) PCT Filed: Oct. 23, 2009
(86) PCT No.: PCT/EP2009/064003

§ 371 Date: Jul. 28, 2011

(30) Foreign Application Priority Data
Oct. 24, 2008 (FR) 0805918

(51) Int. Cl. G06F 15/16

(52) U.S. Cl. 709/206

(57) ABSTRACT

A tool for the supervision and/or hypervision of a set of systems of different security levels, the systems transmitting messages, includes a display system, and further includes, for each supervised network, at least one gateway for converting the messages to image data, said gateways transmitting said image data via a one-way video link to the display system, at least one of the supervised networks being of a higher security level than the area in which the display system is placed. The invention applies notably to the centralized supervision of several information systems when said systems are subjected to different security constraints.

The present invention relates to a tool for the supervision and/or hypervision of a set of systems of different security levels. It applies notably to the centralized supervision of several information systems when said systems are subjected to unequal security constraints.

In order to supervise entities such as information systems, protected rooms, production or control systems, it is known practice to employ a centralized supervision or hypervision tool. A supervision tool assembles in one and the same location indicators originating from various supervised entities in order to offer an overview of the state of said entities. A hypervision tool offers, in addition to the supervision tool, a synthetic view of the state indicators, correlations being able to be made between indicators originating from distinct entities.

However, when the levels of sensitivity of the data handled on each of the networks are different, the centralized supervision of said networks becomes difficult because of the constraints imposed by the rules aimed at protecting the data. The interconnection of a first system, with a high security level, with a second system, with a lower security level, poses at least two types of problems: the leakage of sensitive information from the first system to the second system and the intrusions originating from the second system.

Conventionally, the supervision centers are then installed in the network of highest security, the other networks being linked via one-way links to the supervision center in order to feed said center with state indicators. Since communications are made only in the uplink direction, no leakage of information present in the network of highest security level is possible. However, the regulation applied to the level of the network of highest security usually induces the application of costly constraints, both from the technical point of view and in matters of training, organization and personnel authorization.

In order to place a supervision center in a network of lower security, in order to avoid the abovementioned constraints, it is known practice to use an interconnection system of multiple security levels. According to one operating mode, such a multilevel system is first configured in order to define what types of data are confidential. Labeling of the data streams is carried out in order to distinguish the confidential data streams from the data streams that are not very sensitive. It is therefore necessary to define manually, for each of the communication protocols used, labels and filtering rules to be applied. This manual configuration phase is protracted and costly. Moreover, the labels applied to the data streams must be signed by cryptographic keys, which requires the use of a key-management infrastructure.

Finally, a supervision and/or hypervision tool must be able to transmit possible alarms in real time, which also excludes the solutions that make use of a manual operation for filtering the sensitive information.

One object of the invention is to propose a less costly supervision and/or hypervision system capable of operating in a network of relatively low security and making it possible to collect and centralize in real or virtually real time, without risk of compromising sensitive data, information originating from networks of higher security levels. Accordingly, the subject of the invention is a tool for the centralized supervision and/or hypervision of a set of systems of different security levels, said systems transmitting messages, said tool comprising a display system, the tool being characterized in that at least one supervised system comprises one or more gateways for converting the transmitted messages to image data, said gateways transmitting said image data via a one-way link to the display system, at least one of the supervised systems being of a higher security level than the security level of the area in which the display system is placed.

The tool according to the invention carries out a semantic break of the information. One advantage of this break is that the image data originating from the conversion is difficult to interpret by a programmable controller, unlike textual data, that can be directly used by an analysis software program. The creation of auxiliary channels is therefore made difficult. Moreover, unlike what is done conventionally in the matter of security, the one-way link transmits information from the network of high protection level to a network of lower protection level.

According to one embodiment of the centralized supervision and/or hypervision tool according to the invention, at least one supervised system comprises a gateway capable of assembling several messages transmitted by said supervised system in order to generate a message with coarser semantic content.

This message assembly makes it possible to mix several items of information in order to reduce the risks of compromising sensitive data.

According to one embodiment of the centralized supervision and/or hypervision tool according to the invention, the one-way links are video links carrying out a display transfer from a gateway to a screen. This embodiment reduces the risks of information technology intrusion, the link being dedicated solely to the display of images. The display system may then comprise one or more screens, at least one screen being associated with each supervised system, a one-way link linking a supervised system to the screen or screens that are associated therewith. A “wall of images” can therefore be produced so that a human operator having access to the display system has at his disposal an overview of the networks of different security levels.

According to another embodiment of the centralized supervision and/or hypervision tool according to the invention, at least one one-way link is a network link capable of transporting the image data, the display device comprising at least one screen linked to a processing module receiving said images, the processing module being fitted with a software program capable of representing the images originating from several networks on the same screen. This embodiment makes it possible to obtain a synthetic representation of the state of the various networks on one and the same screen.

According to one embodiment of the centralized supervision and/or hypervision tool according to the invention, the messages are SNMP/UDP (“Simple Network Management Protocol”/“User Datagram Protocol”) messages, the gateway comprising an adapter capable of converting the SNMP/UDP messages to images.

According to one embodiment of the centralized supervision and/or hypervision tool according to the invention, at least one gateway is suitable for converting the messages to image data as a function of the semantic content of said messages, unlike what is done conventionally by simple tools for converting a data format.

According to one embodiment of the centralized supervision and/or hypervision tool according to the invention, the messages are state indicators, the images originating from the conversion of said messages being symbolic representations of the semantic content of said indicators.

A further subject of the invention is a method for the centralized supervision and/or hypervision of a set of systems of different security levels, at least one supervised system comprising one or more gateways and sensors and/or alarm devices transmitting messages, said gateways being linked to one and the same display system, the method comprising, for at least one supervised system of higher security level than the security level of the area in which the display system is placed, at least the following steps:
a gateway comprised by said supervised system receives and converts the transmitted messages to image data;
said gateway transmits, via a one-way link, the image data to the display system.

According to one application of the method according to the invention, the method also comprises a step during which a gateway assembles several messages in order to create a message with coarser semantic content.

Other features will appear on reading the following nonlimiting detailed description given as an example and made with respect to the appended drawings which represent:

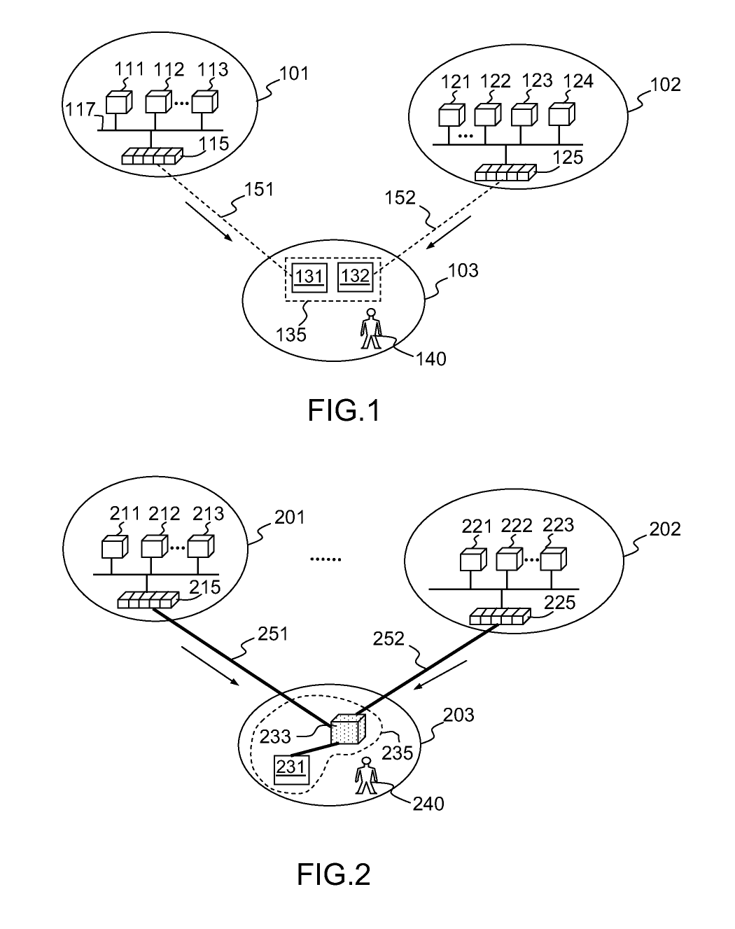

FIG. 1, a first embodiment of the hypervision tool according to the invention,

FIG. 2, a second embodiment of the hypervision tool according to the invention,

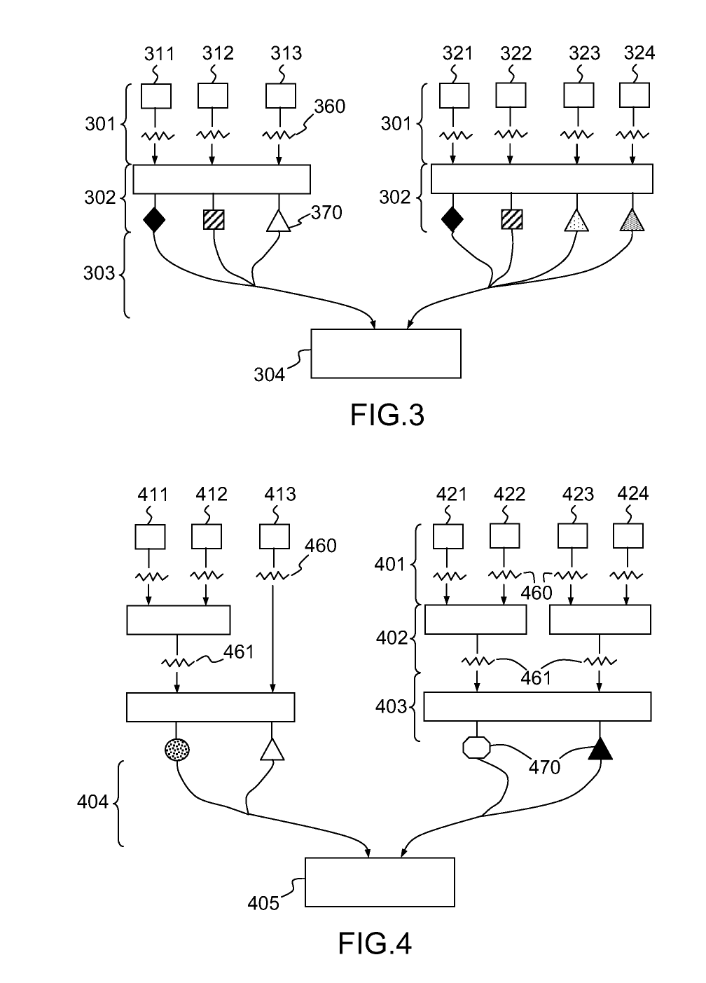

FIG. 3, a block diagram illustrating a first example of the method according to the invention,

FIG. 4, a block diagram illustrating a second example of the method according to the invention.

FIG. 1 presents a first embodiment of the supervision/hypervision tool according to the invention. The supervision/hypervision tool of FIG. 1 is designed to supervise independent networks 101, 102 from an area 103 subjected to a lower level of security than at least one of the supervised networks 101, 102. In the example, the first supervised network 101 is subjected to a maximum security level, the second supervised network 102 is subjected to an intermediate security level, and the area 103 from which the networks are supervised is subjected to a minimal security level.

The tool according to the invention comprises a display system 135 placed in the area 103 of minimal security, the display system 135 comprising at least one screen, two screens 131, 132 in the example of FIG. 1. The display system 135 allows a supervision agent 140 to know at all times the situation of the supervised networks 101, 102.

The first supervised network 101 comprises sensors and/or alarm devices 111, 112, 113 linked to a gateway 115. The sensors and/or alarm devices 111, 112, 113 generate messages, for example to indicate their state. As an illustration, a temperature sensor 111 is capable of transmitting a message that can take optionally three different values: “normal temperature”, “high temperature”, “fire”; an alarm device 112 placed on a safe can transmit two optional states: “safe open” or “safe closed”; a workstation provided with an anti-intrusion detection software program can transmit optionally four states: “normal operation”, “intrusion attempt”, “intrusion detected” or “out of service”. The messages are transmitted to the gateway 115, for example via a computer network 117 of the Ethernet type. According to one embodiment of the supervision/hypervision tool according to the invention, the simple network management protocol SNMP is used to raise alarms. The messages can then be conveyed to the gateway 115 via UDP “User Datagram Protocol”) datagrams, for example.

The gateway 115 converts the messages from the sensors and/or alarm devices 111, 112, 113 to images. In other words, the codes or the textual data contained in the messages are interpreted by the gateway 115 which, depending on the nature and/or the value of the message, creates an image symbolizing the semantic content of the message. Thus, the gateway receives messages as an input, but produces only images as an output, so that a considerable formal break is made by the gateway 115. As an example, to reuse the aforementioned example of the temperature sensor, an image in the form of a green diamond is produced when the received message is “normal temperature”, an orange diamond for the value “high temperature” and a red diamond when the message takes the “fire” value. The images can be produced at frequent intervals so as to generate a video stream.

Moreover, according to one embodiment of the tool according to the invention, the gateway 115 combines several messages before converting the result of this combination to an image. For example, if the gateway 115 receives a “normal temperature” message from a first temperature sensor and another “high temperature” message from a second sensor that is present in the same network as the first sensor, then a synthetic form in order to represent these two items of information combined is generated, for example an orange hexagon instead of two respectively green and orange diamonds. This assembly of information makes it possible to generate an image with coarser semantic content, in this instance, the generated image means “at least one of the two sensors has detected too high a temperature”. Thus, from an external point of view, only this coarse information can be known, thus limiting the risk of compromising sensitive data. In the example, this assembly of data can be used if knowledge of the temperature on only one of the two sensors is confidential information. According to this embodiment, the gateway 115 therefore carries out two processes to limit the leakage of confidential data: the assembly of information carried by the messages and the formal break described above.

Once an image has been produced by the gateway 115, this image is transmitted to the first screen 131 of the display system 135 via a one-way video link 151. In other words, the link 151 is produced so that no data can travel from the display device 135 to the gateway 115. According to the embodiment shown in FIG. 1, the link 151 does not transport computer data packages; this link simply allows the transfer of display to a screen 131 that is remote from the gateway 115.

The second supervised network 102 comprises a structure similar to that of the first network 101, that is to say sensors and/or alarm devices 121, 122, 123, 124 linked to a gateway 125 which transmits image data to the second screen 132 of the display device 135 via a second one-way link 152.

According to another embodiment, each of the supervised networks 101, 102 can comprise several gateways, the display transfer then being carried out for each of the gateways.

FIG. 2 shows a second embodiment of the supervision/hypervision tool according to the invention. The supervision/hypervision tool of FIG. 2 is designed to supervise independent networks 201, 202 from an area 203 subjected to a lower security level than at least one of the supervised networks 201, 202. In the example, the first supervised network 201 is subjected to a maximum security level, the second supervised network 202 is subjected to an intermediate security level, and the area 203 from which the networks are supervised is subjected to a minimal security level.

According to this second embodiment, the tool according to the invention comprises a display system 235 placed in the area 203 of minimal security, the display system 235 comprising at least one screen 231 and a processing module 233 which is for example a computer station.

In the same manner as in the first embodiment shown in FIG. 1, at least one gateway 215, 225 that is present in a supervised network 201, 202 converts the messages transmitted by sensors 211, 212, 213, 212, 222, 223 to images.

Nevertheless, unlike the first embodiment, the images are transmitted from each of the gateways 215, 225 to the display device 235 via a one-way network link 251, 252 and the use of a nonconnected protocol. The images are then received by the processing module 233 which combines the images received from the various networks in order to produce a synthetic graphic representation, this representation being displayed on the screen 231 associated with the processing module 233.

FIG. 3, a block diagram illustrating a first example of the method according to the invention.

For a network to be supervised, initially 301, sensors 311, 312, 313, 321, 322, 323, 324 of the network produce messages 360, for example in the form of code or of text. Secondly 302, the semantic content of the messages 360 is interpreted and converted to image 370 by a gateway. Thirdly 303, the previously produced images 370 are transmitted via a one-way link to the display device.

Fourthly 304, the display device uses the images 370 originating from the various networks to produce a graphic representation of the supervised situation.

FIG. 4, a block diagram illustrating a second example of the method according to the invention comprising an additional step of semantic assembly of messages.

For a network to be supervised, initially 401, sensors 411, 412, 413, 421, 422, 423, 424 of the network produce messages 460, for example in the form of code or of text. Secondly 402, messages 460 are assembled to form a message 461 with coarser semantic content. Thirdly 403, the semantic content of the messages 460, 461 is interpreted and converted to image 470 by a gateway.

Fourthly 404, the previously produced images 470 are transmitted via a one-way link to the display device.

Fifthly 405, the display device uses the images 470 originating from the various networks to produce a graphic representation of the supervised situation.

The supervision/hypervision tool according to the invention may, for example, be used by an enterprise for supervising the integrity of its computer networks and of its safe rooms, these networks and rooms being independent of one another, certain networks and rooms being more sensitive than others. In this context, the supervision/hypervision tool is preferably placed in a not very sensitive area, for example in the reception of the place of business. A supervision agent with no particular need for qualification or accreditation is then responsible for monitoring the tool in order to transmit to the qualified people a possible alarm raised on one of the supervised systems. The tool according to the invention is therefore used to carry out passive supervision by the agent, who has no role of intervening on the network that has raised the alarm.

1. A tool for the centralized supervision and/or hypervision of a set of systems of different security levels, said systems transmitting messages, said tool comprising a display system, wherein at least one supervised system comprises one or more gateways for converting the transmitted messages to image data, said gateways transmitting said image data via a one-way link to the display system, at least one of the supervised systems being of a higher security level than the security level of the area in which the display system is placed.

2. The centralized supervision and/or hypervision tool as claimed in claim 1, wherein at least one supervised system comprises a gateway capable of assembling several messages transmitted by said supervised system in order to generate a message with coarser semantic content.

3. The centralized supervision and/or hypervision tool as claimed in claim 1, wherein the one-way links are video links carrying out a display transfer from a gateway to a screen.

4. The centralized supervision and/or hypervision tool as claimed in claim 3, wherein the display system comprises one or more screens, at least one screen being associated with each supervised system, a one-way link linking a supervised system to the screen or screens that are associated therewith.

5. The centralized supervision and/or hypervision tool as claimed in claim 1, wherein at least one one-way link is a network link capable of transporting the image data, the display system comprising at least one screen linked to a processing module receiving said images, the processing module (2233) being fitted with a software program capable of representing the images originating from several systems on the same screen.

6. The centralized supervision and/or hypervision tool as claimed in claim 1 wherein the messages are SNMP/UDP messages, the gateway comprising an adapter capable of converting the SNMP/UDP messages to images.

7. The centralized supervision and/or hypervision tool as claimed in claim 1 wherein at least one gateway is suitable for converting the messages to image data as a function of the semantic content of said messages.

8. The centralized supervision and/or hypervision tool as claimed in claim 1 wherein the messages are state indicators, the images originating from the conversion of said messages being symbolic representations of the semantic content of said indicators.

9. A method for centralized supervision and/or hypervision of a set of systems of different security levels, at least one supervised system comprising one or more gateways and sensors and/or alarm devices transmitting messages, said gateways being linked to one and the same display system, the method comprising, for at least one supervised system of higher security level than the security level of the area in which the display system is placed, at least the following steps:
a gateway comprised by said supervised system receives and converts the transmitted messages to image data;
said gateway transmits, via a one-way link, the image data to the display system.

10. The centralized supervision and/or hypervision method as claimed in claim 9, further comprising a step during which a gateway assembles several messages in order to create a message with coarser semantic content.
